(19) United States
(12) Patent Application Publication
(10) Pub. No.: US 2015/0341704 A1
(43) Pub. Date: Nov. 26, 2015

(54) METHOD OF TRANSMITTING VIDEO TO RECEIVER INCLUDING HEAD-MOUNTED DISPLAY THROUGH NETWORK AND TRANSMITTER, RELAY SERVER AND RECEIVER FOR THE SAME

(71) Applicant: FXGear Inc., Seoul (KR)

(72) Inventors: Kwang Jin CHOI, Seoul (KR); Yeong Jun PARK, Goyang-si (KR); Kyung Kun NA, Seoul (KR)

(21) Appl. No.: 14/706,811

(22) Filed: May 7, 2015

(30) Foreign Application Priority Data
May 20, 2014 (KR) 10-2014-0060314

(51) Int. Cl. H04N 21/63; H04N 21/414; G06T 19/00; G02B 27/01; H04N 5/38

(52) U.S. Cl. CPC H04N 21/632; G02B 27/0172; H04N 5/38; G06T 19/006; H04N 21/414; G02B 2027/0138

(57) ABSTRACT

A method of transmitting a video to a receiver including a head-mounted display (HMD) over a network includes: determining at least one of a transmitter to transmit wide viewing angle video data and a receiver including a HMD to receive the wide viewing angle video data based on information stored in a user equipment or a relay server, and transmitting the wide viewing angle video data from the transmitter to the receiver through a transmission channel over a wide area network. A sender or recipient of a video selects a recipient or a sender using a local directory stored in a user equipment of the sender or recipient, or a user directory or public information stored in a communication service server, for example, a social network service (SNS), a messenger service, and a web site.

### CROSS-REFERENCE TO RELATED APPLICATION

This application claims priority to Korean Patent Application No. 10-2014-0060314, filed on May 20, 2014, and all the benefits accruing therefrom under 35 U.S.C. §119, the contents of which in its entirety are herein incorporated by reference.

### BACKGROUND

1. Field

Embodiments relate to a method of transmitting a video to a receiver including a head-mounted display (HMD) over a network, and a transmitter, a relay server and a receiver for the same. More particularly, embodiments relate to transmission technology of video data to a receiver including a HMD in real time over a wide area network.

2. Description of the Related Art

Recently, with the development of various types of video devices, there is a growing demand from users who want to view videos with richer vividness and stereoscopic feelings through video devices. In keeping with this demand, video device providers offer stereoscopic videos by modifying the acquisition and processing mechanism of video content, or provide virtual videos that are too realistic for users to distinguish from real life by connecting various supplemental means to video providing devices. For example, there is technology that provides a user with a feel as if the user really participates in a video environment by simultaneously displaying videos taken from different views using binocular disparity to provide stereoscopic videos, or by covering an entire visual field of the user with the videos to present panoramic videos.

As one of the supplemental means for this technology, a head-mounted display (HMD) is gaining attention. Generally, a HMD is worn on the head of a user in the form of glasses, a cap, or a helmet, and provides videos through a display attached near lenses. The HMD provides videos in panorama format through the display while blocking the visual field of both eyes of the user by the corresponding display, and although it has a smaller display size than a portable video device such as a tablet or a portable multimedia player (PMP), it provides a wider display than an actual display, thereby providing the user with a more realistic experience in virtual reality.

### SUMMARY

According to an aspect of the present disclosure, there is provided a method of transmitting a video to a receiver including a head-mounted display (HMD) in real time over a wide area network, and a transmitter, a relay server and a receiver therefor.

According to an embodiment, a transmitter for transmitting a video to a receiver including a HMD includes: a processing unit configured to provide wide viewing angle video data, and a communication unit configured to determine a receiver including a HMD to receive the wide viewing angle video data based on information stored in the transmitter or a relay server, and to transmit the wide viewing angle video data to the receiver through a transmission channel over a wide area network.

According to an embodiment, a relay server for transmitting a video to a receiver including a HMD includes a receiving unit configured to receive a transmission request for wide viewing angle video data from at least one transmitter, and a relay unit configured to generate a transmission channel over a wide area network, through which the wide viewing angle video data is transmitted to at least one receiver including a HMD.

According to an embodiment, a receiver including a HMD includes a receiving unit configured to determine a transmitter to provide wide viewing angle video data to the receiver based on information stored in the receiver or a relay server, and to receive the wide viewing angle video data through a transmission channel over a wide area network.

According to an embodiment, a method of transmitting a video to a receiver including a HMD over a network includes: determining at least one of a transmitter to transmit wide viewing angle video data and a receiver including a HMD to receive the wide viewing angle video data based on information stored in a user equipment or a relay server, and transmitting the wide viewing angle video data from the transmitter to the receiver through a transmission channel over a wide area network.

According to an aspect of the present disclosure, in an attempt to transmit or receive a video to or from a receiver including a HMD, a sender or recipient of the video may select a recipient or sender using a local directory stored in a user equipment of the sender or recipient, or a user directory or public information stored in a communication service server, for example, a social network service (SNS), a messenger service, and a web site. Also, the video to be transmitted and received may be transmitted and received through a communication service server, for example, an SNS, a messenger service, a web site. Thus, the video may be freely transmitted to a receiver including an HMD using a peer-to-peer technique between users as well.

### BRIEF DESCRIPTION OF THE DRAWINGS

FIG. 1 is a schematic block diagram illustrating the architecture of a system including a transmitter and a relay server for transmitting a video to a receiver including a head-mounted display (HMD) according to an embodiment.

FIGS. 2A and 2B are conceptual diagrams illustrating a process of forming a channel between a transmitter and a receiver including a HMD according to an embodiment.

FIG. 3 is a conceptual diagram illustrating channels formed between multiple transmitters and multiple receivers including HMDs according to an embodiment.

FIG. 4 is a schematic block diagram illustrating a configuration of a channel/address relay server according to an embodiment.

FIG. 5 is a schematic block diagram illustrating a configuration of a media relay server according to another embodiment.

### DETAILED DESCRIPTION

Hereinafter, embodiments of the present disclosure will be described in detail with reference to the accompanying drawings.

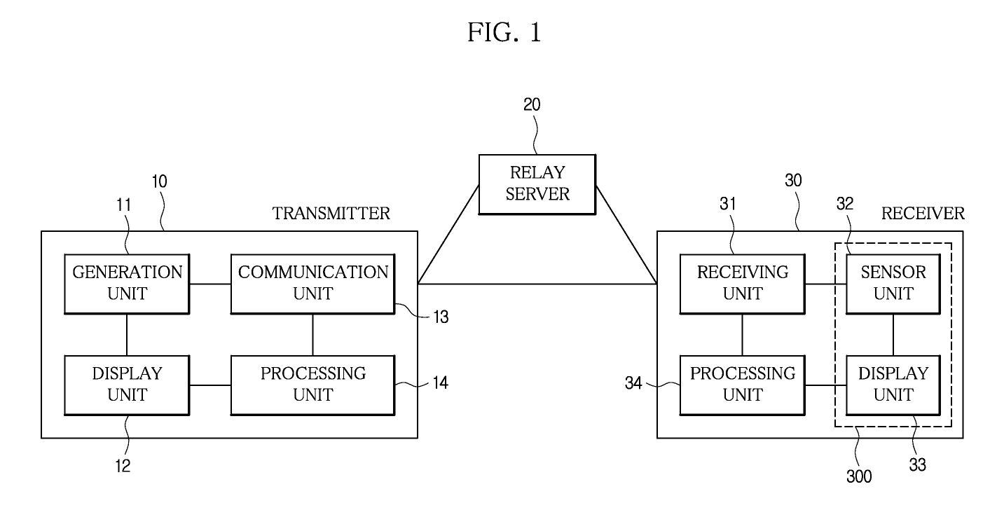

FIG. 1 is a schematic block diagram illustrating the architecture of a system including a transmitter and a relay server for transmitting a video to a receiver including a head-mounted display (HMD) according to an embodiment.

Referring to FIG. 1, the transmitter 10 is a device for use by a content provider who intends to provide wide viewing angle video data to the receiver 30. The receiver 30 is a device for use by a recipient who will receive the wide viewing angle video data, and the receiver 30 includes the HMD. In the following specification, unless otherwise indicated, the term “receiver” is intended to refer to a device including a HMD. Also, similar to the receiver 30 that will receive the wide viewing angle video data, the transmitter 10 may be a device including a HMD, but is not limited thereto, and may include a desktop computer, a laptop computer, a mobile communication terminal having a camera mounted thereon such as a smartphone or a tablet, or any other device. Although FIG. 1 illustrates one transmitter 10 for convenience of description, the receiver 30 may be provided with the wide viewing angle video data from multiple transmitters 10. Also, multiple receivers 30 may be provided to receive the wide viewing angle video data from one or multiple transmitters 10.

In one embodiment, the transmitter 10 may include a generation unit 11, a display unit 12, a communication unit 13, and a processing unit 14. However, this is illustrative of an exemplary structure of the transmitter 10 classified by function, and the transmitter 10 may not necessarily include all the elements, or may include an additional element not illustrated, for example, an input unit.

The generation unit 11 acquires original video data for wide viewing angle video data. For example, the generation unit 11 may include a camera. The display unit 12 plays the recorded video data to allow a user to see. The processing unit 14 provides wide viewing angle video data obtained by processing the video data recorded by the generation unit 11.

In one embodiment, the transmitter 10 processes the video data, recorded by the generation unit 11, by the processing unit 14 to generate wide viewing angle video data. For example, the processing unit 14 converts the original video data to a video feed suitable to be displayed on the HMD to generate wide viewing angle video data and metadata. Also, the processing unit 14 may generate the wide viewing angle video data further including miscellaneous data corresponding to the video feed, for example, text, audio, and an image, or unique data for classification and connection of devices on a network. For example, the unique data may include, but is not limited to, an identification (ID), a product Identification number (PIN), or an Internet Protocol (IP) address corresponding to the transmitter 10.

In another embodiment, the transmitter 10 may transmit the video data recorded by the generation unit 11 to other processing units (not shown) at a local or remote location to allow the video data to be processed by the processing units, instead of directly processing the video data in the processing unit 14 of the transmitter 10. Herein, the processing unit 14 may only act to receive and provide wide viewing angle video data generated by the processing units. In this instance, the processing unit 14 may at least partially store the received wide viewing angle video data.

The communication unit 13 transmits a series of data including the wide viewing angle video data provided by the processing unit 14 to the receiver 30 over a network. This transmission may be accomplished by at least partially using the relay server 20. In one embodiment, the communication unit 13 may transmit the wide viewing angle video data at least partially through a transmission channel over a wide area network (WAN). For example, the communication unit 13 may transmit the wide viewing angle video data by connecting to the relay server 20 and/or the receiver 30 using an Internet Protocol (IP) address or other unique data assigned to the relay server 20 and/or the receiver 30.

To determine the receiver 30 which will receive the wide viewing angle video data, the communication unit 13 may determine the receiver 30 based on information stored in the transmitter 10 and/or the relay server 20. For example, the relay server 20 may be an arbitrary communication service server that enables communication with other users, for example, a cloud service server, a social network service (SNS) server, or a messenger service server. The communication unit 13 may determine a recipient using information stored in a local storage of the transmitter 10 or information stored in the relay server 20, and may provide the wide viewing angle video data to the receiver 30 corresponding to the determined recipient.

That is, a user using the transmitter 10 according to one embodiment may select a recipient to receive the wide viewing angle video data of the user using a local directory of the user that is stored in the transmitter 10 or a directory of the user registered in, for example, an SNS server and a messenger service server. In this case, the SNS server and the messenger service server correspond to the relay server 20. Alternatively, the user using the transmitter 10 may select a recipient using published information registered in a web site. In this case, a server providing the corresponding web site corresponds to the relay server 20. As opposed to the prior art designed to provide video data from a centralized server, according to this embodiment, sharing of wide viewing angle video data may be enabled using a peer-to-peer (P2P) technique over a network between individuals as well.

In the embodiments, the wide viewing angle video data provided to the receiver 30 by the transmitter 10 may be live video data provided in a real-time streaming format, or a video data provided in a non-live format. Also, the wide viewing angle video data may include a single video, multiple videos, a sequence containing a series of single videos and/or multiple videos consecutively arranged, a single video or multiple videos being split in response to a signal from a user equipment or a server, an interactive video that changes in response to a signal from a user equipment or a server, and a combination of some or all of them. In the following specification, the term “video” is not limited to a particular type such as whether it is live or not, the number of videos, or reactivity in the foregoing description, and is intended to indicate arbitrary data that may be displayed based on a user view on a receiver including a HMD.

The receiver 30 is a device for use by a recipient that will receive the wide viewing angle video data provided by the transmitter 10. In the embodiments, the wide viewing angle video data provided by the transmitter 10 may be transmitted to the receiver 30 by a direct connection between the transmitter 10 and the receiver 30, or by a connection between the transmitter 10 and the receiver 30 through the relay of the relay server 20, or after transmitted to the relay server 20, the wide viewing angle video data may be transmitted from the relay server 20 to the receiver 30. A detailed description will be provided later.

In one embodiment, the receiver 30 may include a receiving unit 31, a sensor unit 32, a display unit 33, and a processing unit 34. Among them, the sensor unit 32 and the display unit 33 may be mounted in the HMD 300 included in the receiver 30. However, this is illustrative of an exemplary structure of the HMD 300 and the receiver 30 including the HMD 300 classified by function, and the HMD 300 and the receiver 30 including the HMD 300 may not necessarily include all the elements, or may include an additional element not illustrated, for example, an input means.

The receiving unit 31 receives the wide viewing angle video data from the transmitter 10 over a network. The receiving may be accomplished at least partially using the relay server 20. Similar to the description in relation to the transmitter 10, the receiving unit 31 may receive the wide viewing angle video data from the transmitter 10 at least partially through a transmission channel via the WAN. The wide viewing angle video data received by the receiving unit 31 may include a video feed to be displayed on the HMD 300 in accordance with the user's viewpoint. Also, the wide viewing angle video data may further include metadata corresponding to the video feed, for example, a text, an audio, and an image, or unique data for classification and connection of devices on a network.

In one embodiment, the receiving unit 31 may determine the transmitter 10 from which the receiving unit 31 is to receive the wide viewing angle video data. In this instance, the receiving unit 31 may determine the transmitter 10 from which the receiving unit 31 is to receive the wide viewing angle video data, based on information stored in the receiver 30 and/or the relay server 20. For example, a user using the receiver 30 may select a content provider from which the receiver 30 is to receive the wide viewing angle video data using a local directory of the user that is stored in the receiver 30, or a directory of the user registered in, for example, an SNS server and a messenger service server. In this case, the SNS server and the messenger service server correspond to the relay server 20. Alternatively, the user using the receiver 30 may select the content provider using information published on a web site. In this case, a server providing the corresponding web site corresponds to the relay server 20. The receiving unit 31 may receive the wide viewing angle video data from the transmitter 10 corresponding to the selected content provider.

The sensor unit 32 generates view information data of the user wearing the HMD 300. The sensor unit 32 may include at least one sensor to generate the view information data. For example, the sensor unit 32 may include, but is not limited to, at least one of a gyro sensor, an acceleration sensor, an inertial measurement unit (IMU) sensor, a global positioning system (GPS) sensor, and a vision sensor.

The processing unit 34 processes the wide viewing angle video data based on the view information data acquired by the sensor unit 32 to generate view-dependent video data based on a view of the user wearing the HMD 300. That is, when the user wearing the HMD 300 changes the view by turning the user's head, the view-dependent video data may be generated to display a part corresponding to a changed view of the user in original wide viewing angle video data. A method of generating the wide viewing angle video data to be displayed on the HMD 300 or a method of generating the user view-dependent video data using the same is well known to those skilled in the art, and thus, its detailed description is omitted herein.

The display unit 33 is a part corresponding to a display which covers the visual field of both eyes of the user wearing the HMD 300, and displays the view-dependent video data generated by the processing unit 34. In one embodiment, the display unit 33 operates, allowing for mode shifts between a view-dependent play mode and a view-independent play mode in response to a selection by the user, and may be configured to output the view-dependent video data in the view-dependent play mode and output the wide viewing angle video data intactly in the view-independent play mode.

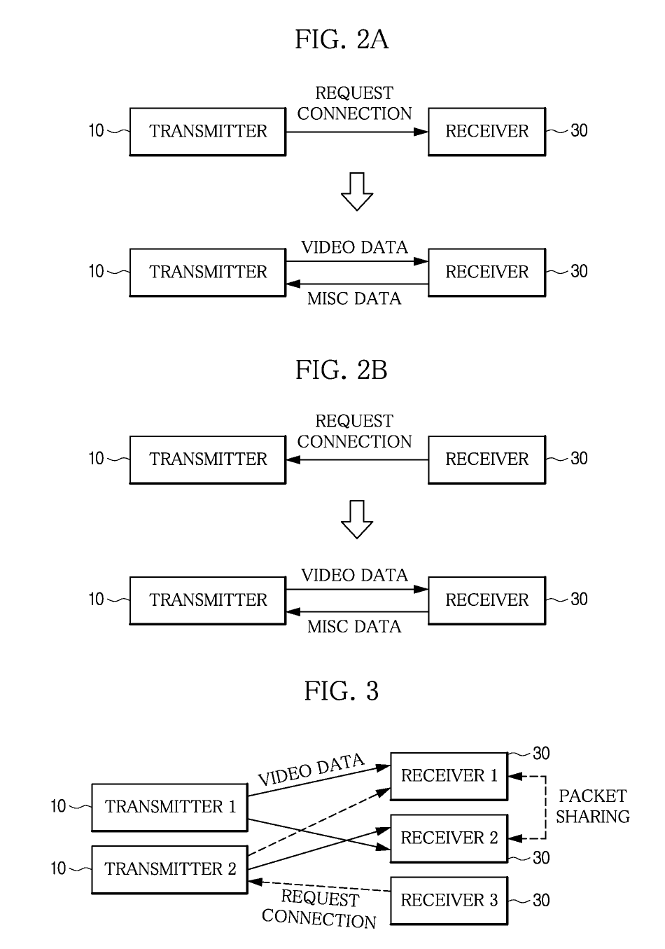

In one embodiment, after the receiver 30 to receive the wide viewing angle video data is selected by the transmitter 10 and/or the transmitter 10 from which the wide viewing angle video data is to be provided is selected by the receiver 30, the wide viewing angle video data may be transmitted to the receiver 30 by a direct connection between the transmitter 10 and the receiver 30. FIG. 2A is a conceptual diagram illustrating a process of forming a transmission channel between the transmitter 10 and the receiver 30 for the transmission according to one embodiment.

Referring to FIG. 2A, the user of the transmitter 10 may transmit a connection request to the receiver 30 to which the wide viewing angle video data is to be transmitted. For example, the user of the transmitter 10 may designate a recipient to receive the wide viewing angle video data through a directory stored in the local storage of the transmitter 10 or through a communication service, for example, an SNS server, a messenger service server, and a web site server. The transmitter 10 may request a connection by transmitting a connection request including unique data of the transmitter 10 such as an ID, a PIN, or an IP address to the receiver 30 corresponding to the designated recipient. When the receiver 30 accepts the connection request, a transmission channel between the transmitter 10 and the receiver 30 may be formed.

When the transmission channel is formed, the transmitter 10 may transmit the wide viewing angle video data to the receiver 30. The wide viewing angle video data being transmitted may include a video feed to be displayed based on a view of the user and metadata corresponding to the video feed, for example, a text, an audio, and an image. Also, the transmitter 10 and the receiver 30 may transmit and receive other data associated or non-associated with the video data through the transmission channel (e.g., miscellaneous data).

FIG. 2B is a conceptual diagram illustrating another process of forming a channel between the transmitter 10 and the receiver 30 according to one embodiment. As opposed to the process described above with reference to FIG. 2A, in the process shown in FIG. 2B, the receiver 30 may request a connection to the transmitter 10. For example, the user of the receiver 30 may designate a content provider from which the wide viewing angle video data is to be received, through a directory stored in the local storage of the receiver 30 or through a communication service, for example, an SNS, a messenger service, and a web site. To the transmitter 10 corresponding to the designated content provider, the receiver 30 may transmit a connection request including unique data of the receiver 30, for example, an ID, a PIN, or an IP address. When the transmitter 10 accepts the connection request, a transmission channel between the transmitter 10 and the receiver 30 is formed. An operation subsequent to the formation of the transmission channel is the same as the operation described above with reference to FIG. 2A, and a detailed description is omitted herein.

FIGS. 2A and 2B illustrate processes of forming a transmission channel by directly connecting one transmitter 10 and one receiver 30 to transmit the wide viewing angle video data. However, this is just for illustration, and in other embodiments, a transmission channel may be formed by a direct connection between some or all of a plurality of transmitters and some or all of a plurality of receivers.

FIG. 3 is a conceptual diagram illustrating transmission channels formed between n transmitters and m receivers 30 according to this embodiment. In the embodiment of FIG. 3 and subsequent embodiments, n and m denote an arbitrary natural number. The direct connection between the transmitter 10 and the receiver 30 described with reference to FIGS. 2A and 2B may be expanded to multiple transmitters and multiple receivers 30 as shown in FIG. 3. That is, the respective transmitters may provide the wide viewing angle video data to one or multiple receivers. Also, the respective receivers may receive the wide viewing angle video data from one or multiple transmitters.

Also, in one embodiment, the receiver may receive the wide viewing angle video data from at least one other receiver using a packet sharing. In the embodiment shown in FIG. 3, Receiver 1 forms a transmission channel with Transmitter 1 and receives wide viewing angle video data from Transmitter 1, whereas Receiver 2 forms transmission channels with both Transmitter 1 and Transmitter 2 and receives wide viewing angle video data from both Transmitter 1 and Transmitter 2. In this instance, although a transmission channel is not formed between Receiver 1 and Transmitter 2, Receiver 1 has a communication connection to Receiver 2 using a packet sharing and may receive wide viewing angle video data from Transmitter 2 through Receiver 2. Receiver 3 may request a connection with transmitter 2.

FIGS. 2 and 3 illustrate a direct connection between the transmitter and the receiver to transmit wide viewing angle video data. However, in this connection, at least one of the transmitter and the receiver may be replaced with a relay server, and the transmitter may transmit and receive data with the receiver via the relay server and/or by a connection through the relay of the relay server. In this case, the relay server may be a communication service server, for example, an SNS, a messenger service, and a web site, or may be a server only for communication relay separately from this service.

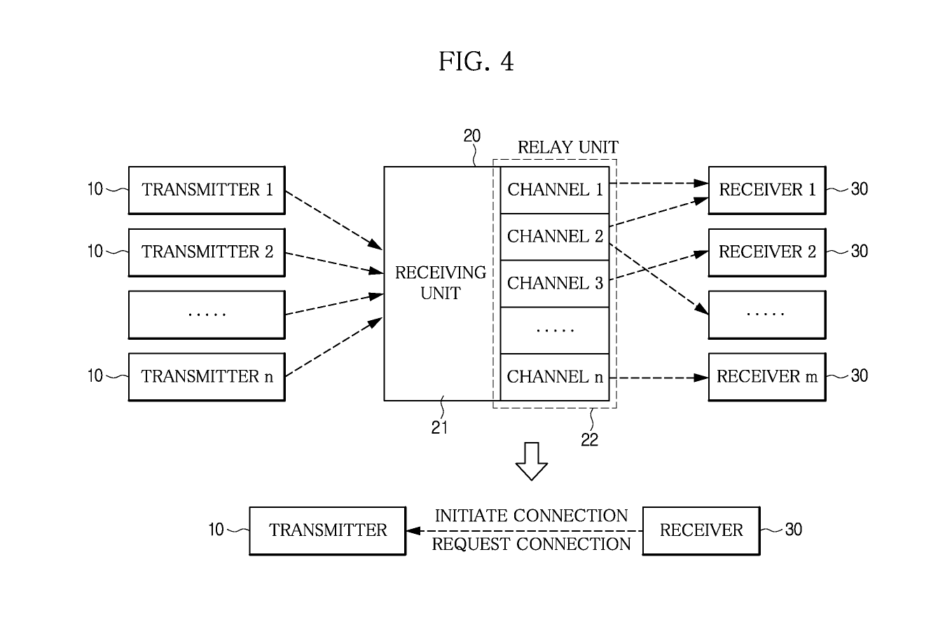

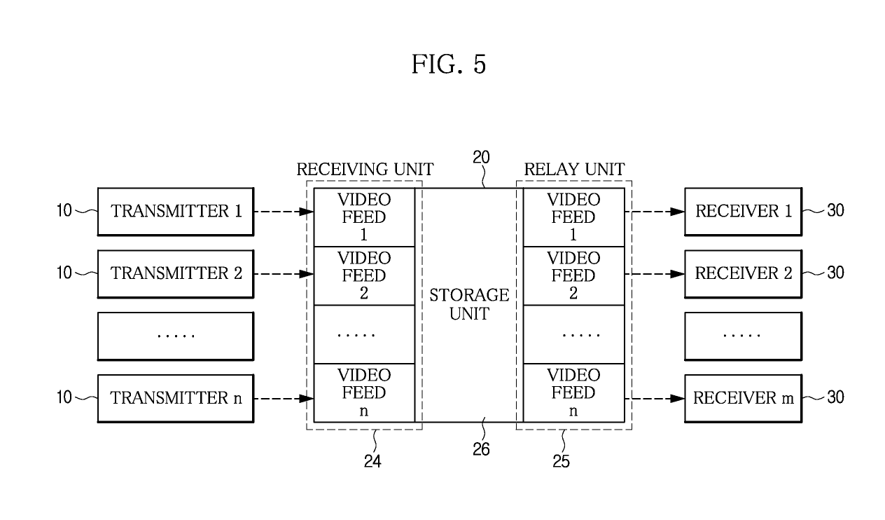

FIG. 4 is a schematic block diagram illustrating the architecture of the relay server according to one embodiment.

Referring to FIG. 4, the multiple transmitters 10 may transmit and receive data with the multiple receivers 30 by a connection through the relay of the relay server 20. In one embodiment, the relay server 20 may include a receiving unit 21 and a relay unit 22. The receiving unit 21 receives, from the respective transmitters 10, a transmission request including information for designating channel identification (CID) information unique to the transmitters 10. For example, the CID may include, but is not limited to, an IP address of the transmitter 10, or an ID for designating the user of the transmitter 10 among subscribers of a communication service, for example, an SNS and a messenger service.

The relay unit 22 provides the CID received from the transmitter 10 to the corresponding receiver 30. In one embodiment, when the transmitter 10 transmits the CID to the relay server 20, a recipient to receive the CID is designated by the transmitter 10 beforehand, and the relay unit 22 may provide the CID of the transmitter 10 to the receiver 30 corresponding to the designated recipient. In other embodiments, in such a state that the transmitter 10 does not designate a recipient, the transmitter 10 transmits the CID to the relay server 20, and the receiver 30 transmits, to the relay server 20, information associated with a provider of content which the receiver 30 is to receive, so the relay unit 22 may transmit the CID of the transmitter 10 corresponding to the corresponding content provider to the receiver 30. In this process, the determination as to the recipient or the content provider may be made, similar to the description with reference to FIG. 1, using a directory of the user stored in the transmitter 10 or the receiver 30, or a user directory or published information stored in a communication service server, for example, an SNS, a messenger service, and a web site.

The receiver 30 receiving the CID of the transmitter 10 may transmit a connection request to the corresponding transmitter 10 using the CID, and when the transmitter 10 accepts the request, a transmission channel between the transmitter 10 and the receiver 30 may be formed. Also, through the formed transmission channel, the transmitter 10 may transmit wide viewing angle video data to the receiver 30.

FIG. 5 is a schematic block diagram illustrating the architecture of the relay server according to another embodiment.

Referring to FIG. 5, a plurality of transmitters 10 may transmit wide viewing angle video data to a plurality of receivers 30 via the relay server 20. That is, the respective transmitters 10 may transmit wide viewing angle video data including the video feed itself to the relay server 20.

In one embodiment, the relay server 20 may include a receiving unit 24, a relay unit 25, and a storage unit 26. The receiving unit 24 receives wide viewing angle video data from the respective transmitters 10, and the storage unit 26 stores at least partially the wide viewing angle video data received by the receiving unit 24. For example, the storage unit 26 may store all the wide viewing angle video data received from the transmitters 10 and transmit it to the receiver 30. Alternatively, the storage unit 26 may transmit the wide viewing angle video data to the receiver 30 in a real-time streaming format, while storing only some of the wide viewing angle video data in a buffer.

The relay unit 25 provides the wide viewing angle video data received from the respective transmitters 10 to the receiver 30. In one embodiment, when the transmitter 10 transmits the wide viewing angle video data to the relay server 20, a recipient to receive the wide viewing angle video data is designated by the transmitter 10 beforehand, and the relay unit 25 may provide the wide viewing angle video data of the corresponding transmitter 10 to the receiver 30 corresponding to the designated recipient. In other embodiments, in such a state that the transmitter 10 does not designate a recipient, the transmitter 10 transmits the wide viewing angle video data to the relay server 20, and the receiver 30 transmits, to the relay server 20, information associated with a provider of content which the receiver 30 is to receive, so the relay unit 25 may transmit the wide viewing angle video data of the transmitter 10 corresponding to the corresponding content provider to the receiver 30. In this process, the determination as to the recipient or the content provider may be made, similar to the description with reference to FIG. 1, using a directory of the user stored in the transmitter 10 or the receiver 30, or a user directory or published information stored in a communication service server, for example, an SNS, a messenger service, and a web site.

According to the embodiments of the present disclosure as described hereinabove, when a content provider intends to transmit an video to a receiver including a HMD, or a user of a receiver including a HMD intends to receive an video, the content provider or the user of the receiver may select a recipient or a content provider using a local directory stored in a device of the content provider or the user of the receiver, or a user directory or published information stored in a communication service server, for example, an SNS, a messenger service, and a web site. In addition, the wide viewing angle video data being transmitted and received may be also transmitted and received through a communication service server, for example, an SNS, a messenger service, and a web site. Thus, the wide-viewing angle video to be displayed on an HMD may be freely shared between users using a P2P technique as well.

The present disclosure has been hereinabove described with reference to the embodiments illustrated in the drawings, but this is just illustrative, and it will be understood by those skilled in the art that various modifications in form and details may be made therefrom. However, such modifications can be construed as being within the technical scope of protection of the present disclosure. Therefore, the true technical scope of protection of the present disclosure shall be defined by the technical aspects of the appended claims.

What is claimed is:

1. A transmitter for transmitting a video to a receiver including a head-mounted display (HMD), the transmitter comprising:
a processing unit configured to provide wide viewing angle video data; and
a communication unit configured to determine a receiver including an HMD to receive the wide viewing angle video data based on information stored in the transmitter or a relay server, and to transmit the wide viewing angle video data to the receiver through a transmission channel over a wide area network.

2. The transmitter according to claim 1, wherein the communication unit is configured to determine a receiver including a HMD to receive the wide viewing angle video data based on a user directory stored in the transmitter or the relay server.

3. The transmitter according to claim 1, wherein the communication unit is configured to form the transmission channel directly connecting the transmitter and the receiver.

4. The transmitter according to claim 1, wherein the communication unit is further configured to transmit channel identification information corresponding to the transmitter to the relay server to form the transmission channel.

5. The transmitter according to claim 1, wherein the communication unit is configured to transmit the wide viewing angle video data to the receiver via the relay server.

6. A relay server for transmitting a video to a receiver including a head-mounted display (HMD), the relay server comprising:
a receiving unit configured to receive a transmission request for wide viewing angle video data from at least one transmitter; and
a relay unit configured to generate a transmission channel over a wide area network, through which the wide viewing angle video data is transmitted to at least one receiver including an HMD.

7. The relay server according to claim 6, wherein the transmission request comprises channel identification information corresponding to the transmitter, and
the relay unit is configured to transmit the channel identification information to the receiver to generate a transmission channel between the transmitter and the receiver.

8. The relay server according to claim 6, wherein the receiving unit is further configured to receive the wide viewing angle video data from the at least one transmitter, and
the relay unit is further configured to transmit the wide viewing angle video data to the receiver through the transmission channel between the relay server and the receiver.

9. The relay server according to claim 8, further comprising a storage unit configured to at least partially store the wide viewing angle video data.

10. A receiver comprising a head-mounted display (HMD),
wherein the receiver further comprises a receiving unit configured to determine a transmitter to provide wide viewing angle video data to the receiver based on information stored in the receiver or a relay server, and to receive the wide viewing angle video data through a transmission channel over a wide area network.

11. The receiver according to claim 10, further comprising:
a sensor unit configured to generate view information data of a user; and
a processing unit configured to process the wide viewing angle video data using the view information data to generate view-dependent video data.

12. The receiver according to claim 10, wherein the receiving unit is further configured to determine the transmitter based on a user directory stored in the receiver or the relay server.

13. The receiver according to claim 10, wherein the receiving unit is configured to form a transmission channel directly connecting the receiving unit and the transmitter.

14. The receiver according to claim 10, wherein the receiving unit is configured to receive channel identification information corresponding to the transmitter from the relay server, and to form a transmission channel between the receiving unit and the transmitter using the channel identification information.

15. The receiver according to claim 10, wherein the receiving unit is configured to receive the wide viewing angle video data through a transmission channel between the receiving unit and the relay server.

16. The receiver according to claim 10, wherein the receiving unit is further configured to receive the wide viewing angle video data from other receiver including a HMD.

17. A method of transmitting a video to a receiver including a head-mounted display (HMD) over a network, the method comprising:
determining at least one of a transmitter to transmit wide viewing angle video data and a receiver comprising a HMD to receive the wide viewing angle video data based on information stored in a user equipment or a relay server; and
transmitting the wide viewing angle video data from the transmitter to the receiver through a transmission channel over a wide area network.

18. The method according to claim 17, wherein determining at least one of the transmitter and the receiver comprises determining at least one of the transmitter and the receiver comprising the HMD based on a user directory stored in the transmitter, the receiver, or the relay server.

19. The method according to claim 17, wherein transmitting the wide viewing angle video data comprises forming a transmission channel directly connecting the transmitter and the receiver.

20. The method according to claim 19, wherein transmitting the wide viewing angle video data further comprises:
before the forming of the transmission channel,
receiving, by the relay server, channel identification information corresponding to the transmitter from the transmitter; and
transmitting, by the relay server, the channel identification information to the receiver.

21. The method according to claim 17, wherein transmitting the wide viewing angle video data comprises:
receiving, by the relay server, the wide viewing angle video data from the transmitter; and
transmitting, by the relay server, the wide viewing angle video data to the receiver.
